(19) United States
(12) Patent Application Publication
(10) Pub. No.: US 2013/0236078 A1
(43) Pub. Date: Sep. 12, 2013

(54) X-RAY IMAGING APPARATUS

(71) Applicants: KABUSHIKI KAISHA TOSHIBA, Tokyo (JP); TOSHIBA MEDICAL SYSTEMS CORPORATION, Otawara-shi (JP)

(72) Inventors: Yoshimasa KOBAYASHI, Nasushiobara-shi (JP); Kyojiro Nambu, Nasushiobara-shi (JP)

(73) Assignees: Toshiba Medical Systems Corporation, Otawara-shi (JP); Kabushiki Kaisha Toshiba, Tokyo (JP)

(21) Appl. No.: 13/770,419

(22) Filed: Feb. 19, 2013

(30) Foreign Application Priority Data
Mar. 7, 2012 (JP) 2012-050482

(51) Int. Cl. G06T 7/00

(52) U.S. Cl. CPC G06T 7/0012
USPC 382/132

(57) ABSTRACT

A medical image interpretation system according to an embodiment of the present invention including: uninterpreted inspection data; known abnormal data in each of which a disease has been diagnosed; an interpretation data generation section that mixes, at a predetermined mixing ratio, the known abnormal data with the uninterpreted inspection data to create interpretation data in which the known abnormal data are inserted in a random position of the uninterpreted inspection data; a true/false determination section that determines true/false of interpretation judgment made for the known abnormal data included in the interpretation data; a totalizing section that totalizer results of interpretation with respect to the known abnormal data; and a message generation section that generates, in accordance with the interpretation result, an alert message to a radiologist.

### CROSS-REFERENCE TO RELATED APPLICATION

This application is based upon and claims the benefit of priority from the Japanese Patent Application No. 2012-050482 filed on Mar. 7, 2012, the entire contents of which are incorporated herein by reference.

### FIELD

The present invention relates to a medical image interpretation system used for interpretation of a medical image.

### BACKGROUND

In recent years, physical checkups using advanced medical equipment such as a general X-ray imaging apparatus, a mammography apparatus, and an X-ray CT apparatus are carried out, and radiologists are under pressure to interpret a large number of medical images of the same sort. However, the radiologists are just human beings, so interpretation of a large number of images may result in sloppy interpretation, which in turn causes them to overlook abnormalities. In order to prevent a misinterpretation, sometimes a countermeasure is taken in which two radiologists interpret the same single inspection data, followed by collation of results of the interpretation. This countermeasure is referred to as double interpretation.

Typically, the number of medical images to be interpreted in one physical checkup is as large as several hundreds to several thousands. However, a percentage of the number of “abnormal” images (images exhibiting a sign of disease) to the total number of the medical images to be interpreted is less than 1%. In particular, in a case of lung cancer, the percentage is further reduced to 0.1%.

Further, there is concern over a reduction of motivation of a radiologist who performs second interpretation in the double interpretation due to the low percentage of the number of the abnormal images and because he or she interprets inspection data whose results have become clear.

A CAD (Computer-Aided Diagnosis) is known as a technique used by radiologists to help interpret medical images. The CAD can present to the radiologists an area suspected of being abnormal through computer-based image analysis. However, even the use of the CAD cannot achieve 100% detection of the abnormal image, and false positive or false negative may occur.

In order to reduce a possibility of such oversight of the radiologists, there is a system in which a time actually required for the interpretation and a standard interpretation time are compared with each other and, when the interpretation time is too short, false operation alert message is displayed to prompt the radiologist to interpret the same medical image once again.

An object of embodiments of the present invention is to provide a medical image diagnosis system which is capable of reducing a possibility that the radiologist may overlook a positive result in his or her interpretation and which is excellent in interpretation efficiency.

### BRIEF DESCRIPTION OF THE DRAWINGS

FIG. 1 is a block diagram illustrating a configuration of a medical image interpretation system according to an embodiment of the present invention;

FIG. 2 is a view explaining mixing of known abnormal data to be performed by a mixing ratio setting section in the embodiment;

FIG. 3 is a block diagram illustrating a configuration of a totalizing section in the embodiment;

FIG. 4 is a flowchart illustrating operation of the medical image interpretation system in the embodiment;

FIG. 5 is a view illustrating an interpretation determination window in the embodiment;

FIG. 6 is a view for explaining totalizing processing to be performed by the totalizing section in the embodiment;

FIG. 7A is a view illustrating an example of display of an interpretation result in the embodiment;

FIG. 7B is a view illustrating another example of the display of an interpretation result in the embodiment; and

FIG. 8 is a view for explaining abnormal image generation processing to be performed by an abnormal image generation section in a second embodiment.

### DETAILED DESCRIPTION

According to an embodiment of the present invention, there is provided a medical image interpretation system including: uninterpreted inspection data; known abnormal data in each of which a disease has been diagnosed; an interpretation data generation section that mixes, at a predetermined mixing ratio, the known abnormal data with the uninterpreted inspection data to create interpretation data in which the known abnormal data are inserted in a random position of the uninterpreted inspection data; a true/false determination section that determines true/false of interpretation judgment made for the known abnormal data included in the interpretation data; a totalizing section that totalizes results of interpretation with respect to the known abnormal data; and a message generation section that generates, in accordance with the interpretation result, an alert message to a radiologist.

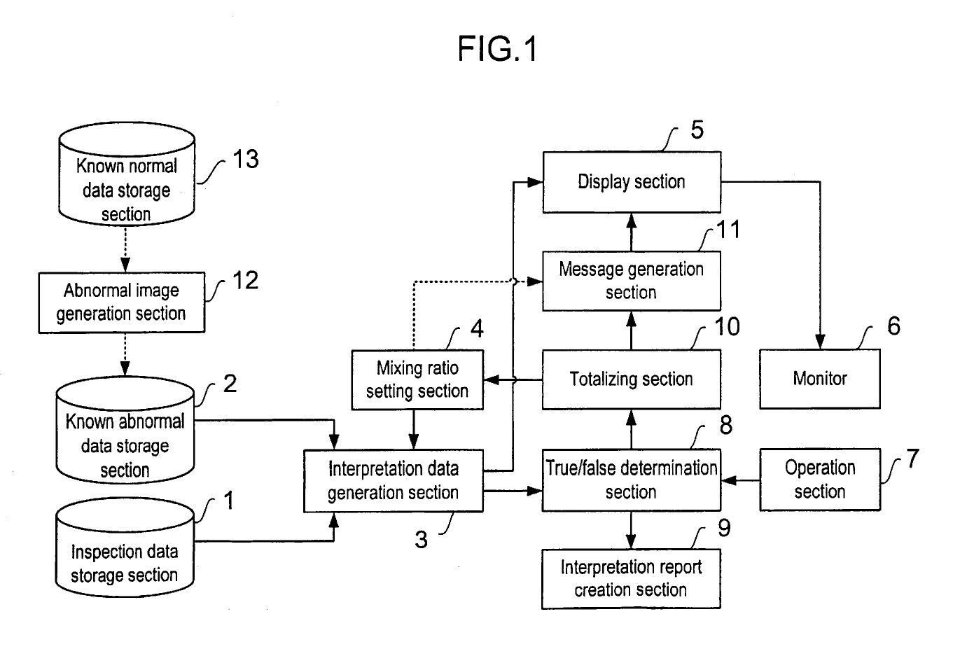

Hereinafter, embodiments for practicing the present invention will be described in detail with reference to FIGS. 1 to 8.

A medical image interpretation system according to embodiments of the present invention is connected to a network in a hospital and can be constructed in cooperation of systems such as a HIS (Hospital Information System), a RIS (Radiology Information Systems), PACS (Picture Archiving and Communication Systems), whereby consistency with existing systems can be easily achieved.

### First Embodiment

As illustrated in FIG. 1, a medical image interpretation system according to the present embodiment includes an inspection data storage section 1, a known abnormal data storage section 2, an interpretation data generation section 3, a mixing ratio setting section 4, a display section 5, a monitor 6, an operation section 7, a true/false determination section 8, an interpretation report creation section 9, a totalizing section 10, a message generation section 11, an abnormal image generation section 12, and a known normal data storage section 13.

The inspection data storage section 1 stores uninterpreted inspection data of medical images of the same sort photographed in physical checkup, etc. The known abnormal data storage section 2 stores known abnormal data. The known abnormal data are normally stored in, e.g., a database of a hospital, which have been photographed in the past and in each of which a disease has been diagnosed. The known abnormal data further include images created by adding images of lesion to normal data. This will be described in detail later.

The interpretation data generation section 3 mixes, at a predetermined mixing ratio, the uninterpreted inspection data stored in the inspection data storage section 1 and the known abnormal data stored in the known abnormal data storage section 2 to thereby create interpretation data. The known abnormal data are mixed in a random order and position with the uninterpreted inspection data.

The mixing ratio setting section 4 sets a mixing ratio of the known abnormal data relative to the uninterpreted inspection data for creation of the interpretation data to be performed in the interpretation data generation section 3 and changes the mixing ratio in accordance with a totalized result from the totalizing section 10.

The display section 5 sequentially displays the interpretation data in the monitor 6 and prompts a radiologist to input an interpretation result indicating whether the judgment interpretation data is abnormal (interpretation data represents a diseased state) or normal (interpretation data represents a non-diseased state) using user interfaces such as a mouse and a keyboard connected to the operation section 7.

The true/false determination section 8 determines true/false of the interpretation judgment result input from the operation section in a case where the interpretation data is the known abnormal data.

The interpretation report creation section 9 performs processing for creation of an interpretation report in a case where the interpretation data is the uninterpreted inspection data.

The totalizing section 10 totalizes the number of trues and falses with respect to the known abnormal data and outputs a totalized result in consideration of progress of the interpretation, such as a decrease in a true/false ratio, a time consumed for the interpretation, and the number of images that have been interpreted.

The message generation section 11 generates, based on the totalized result from the totalizing section 10, various messages such as an alert message or the totalized result to the radiologist.

The abnormal image generation section 12 adds an abnormal (disease) image to a part of the normal (non-disease) image data stored in the known normal data storage section 13 to generate the known abnormal data. Details of the abnormal image generation section 12 will be described in a second embodiment.

The known normal data storage section 13 stores normal images other than the inspection data to be subjected to the interpretation. For example, the normal images are normal inspection data that have been photographed in the past or normal image data stored in a database of other hospitals.

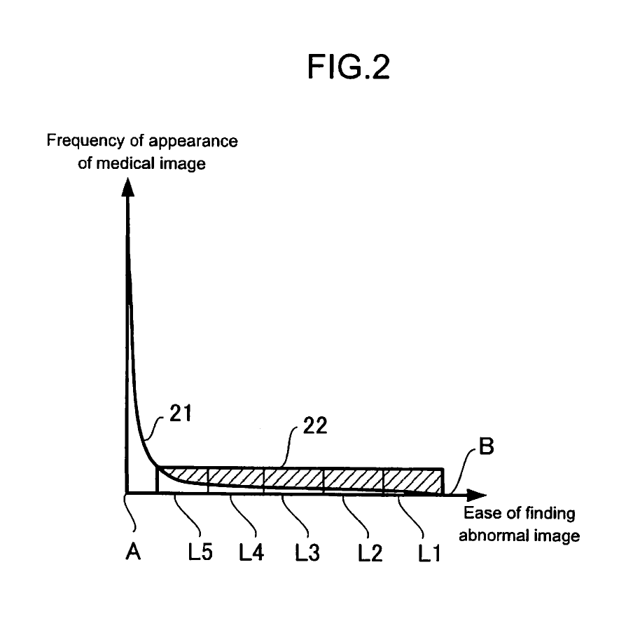

FIG. 2 is a view explaining mixing of the known abnormal data to be performed by the mixing ratio setting section 4. The vertical axis represents a frequency of appearance of the medical image, and the horizontal axis represents ease of finding an abnormal image.

A curve 21 is a statistical histogram for ease of finding the abnormal image included in the interpretation data photographed in a physical checkup. Data near a point A corresponds to normal image data, and data near a point B corresponds to abnormal image data for which anyone can judge presence of abnormality since a disease has significantly progressed.

Therefore, the curve represents that the frequency is high near the point A and becomes low toward the point B. Thus, near the point A where nearly all images are the normal images, it is very difficult to find the disease image. On the other hand, it can be said that 1,000 radiologists out of 1,000 radiologists can find the abnormal image near the point B. As described above, a difficulty level of the interpretation increases toward the point A.

A shaded area 22 represents the mixing ratio of the known abnormal data. The difficulty level of the interpretation is divided into five levels: L1 to L5. The larger the number is, the higher the difficulty of the interpretation. Preferably, in general, one out of tens to hundreds of the known abnormal data is mixed in the entire interpretation data.

In an example of FIG. 2, the known abnormal data in the shaded area 22 are mixed along the statistical histogram 21 so as to make the known abnormal data of the difficulty levels L1 to L5 appear at the same frequency. Alternatively, the mixing ratio can be set independently for each of the difficulty levels L1 to L5 so as to, for example, make the appearance frequency of the difficulty level L3 higher than that of the other difficulty levels.

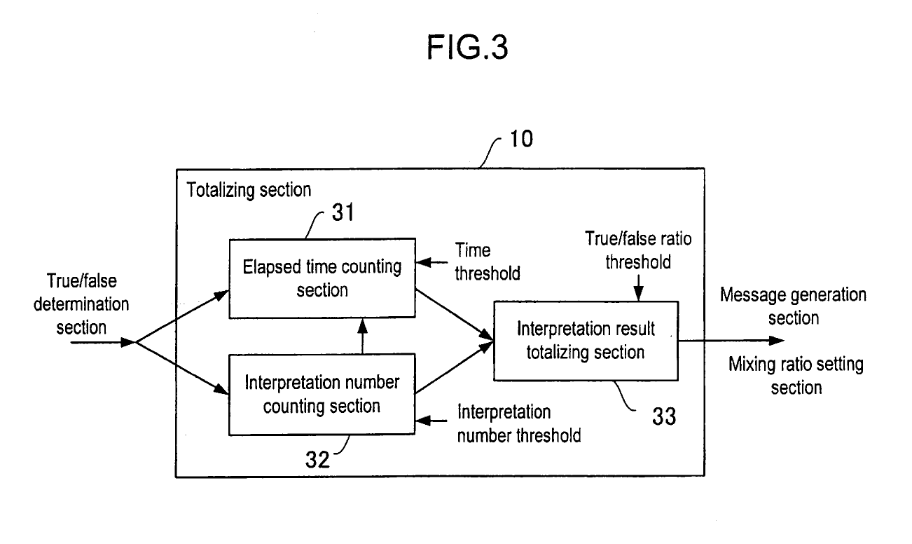

FIG. 3 is a block diagram of the totalizing section 10. The totalizing section 10 includes an elapsed time counting section 31, an interpretation number counting section 32, and an interpretation result totalizing section 33.

The elapsed time counting section 31 counts an interpretation elapsed time, etc. and then compares the counted time with a predetermined time threshold and determines progress of the interpretation. For example, the elapsed time counting section 31 counts (1) an average time consumed for interpretation of one image or (2) a time elapsed from a start of the interpretation. The elapsed time counting section 31 compares the above counted time and a predetermined standard time (time threshold) and determines, based on a magnitude relation between them, whether to provide the alert message to the radiologist or to change the mixing ratio of the known abnormal data, or to perform both operations.

The interpretation number counting section counts the number of interpretations with respect to the known abnormal data and the number of trues and falses with respect thereto. Through this counting, it is possible to determine a progress of the interpretation operation. The counted values are passed to the elapsed time counting section 31 for use in calculation of a time required for interpretation of one image. Further, the interpretation number counting section 32 compares the number of the interpretations and a predetermined interpretation number threshold and determines, based on the magnitude relationship between them, whether to change the mixing ratio of the known abnormal data.

The interpretation result totalizing section totalizes the counted time obtained by the elapsed time counting section 31, the number of interpretations obtained by the interpretation number counting section 32, and true/false ratio of the interpretation with respect to the known abnormal data. Further, the interpretation result totalizing section 33 compares the true/false ratio and a predetermined true/false ratio threshold and determines, based on a magnitude relation between them, whether to provide the alert message to the radiologist or to change the mixing ratio of the known abnormal data, or to perform both operations.

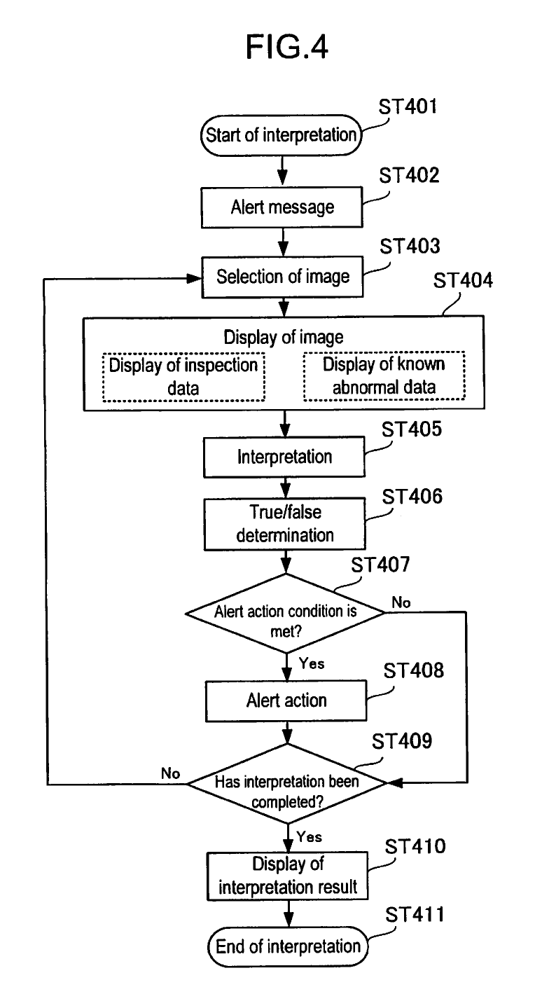

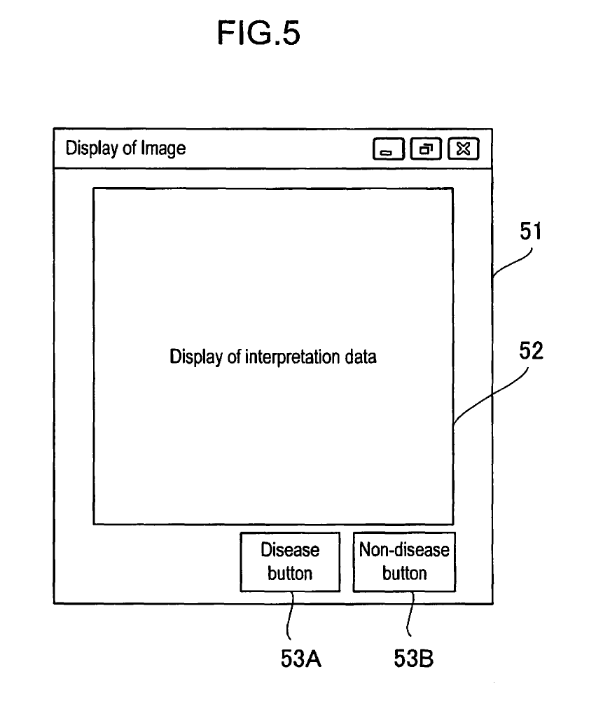

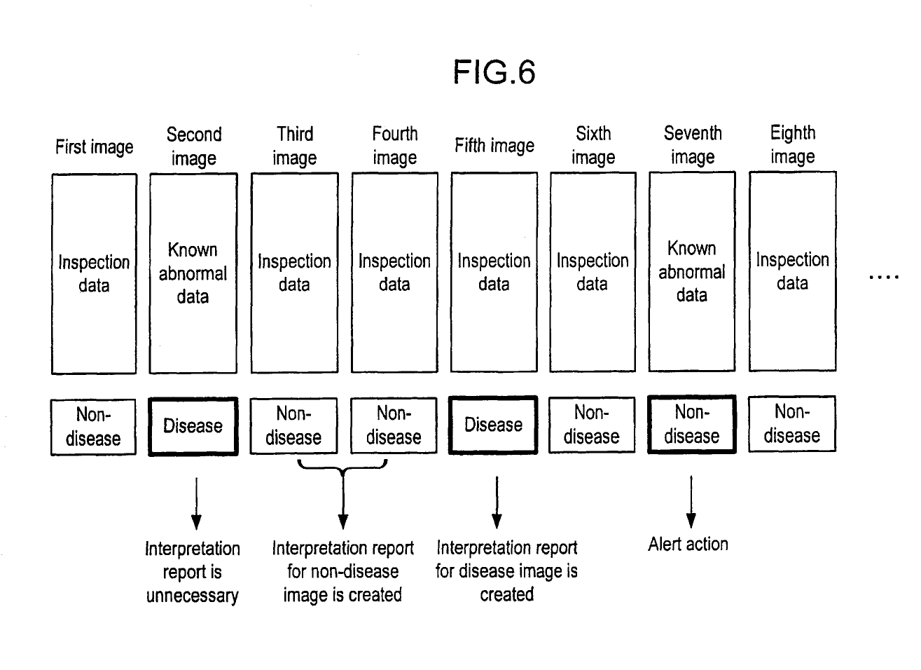

Operation of the medical image interpretation system having the above configuration will be described with reference to FIG. 4. FIG. 5 is a view illustrating a display example of the interpretation data on the monitor and an interpretation judgment input window. FIG. 6 is a view for explaining totalizing processing to be performed by the totalizing section 10.

In step ST401, the interpretation is started. In step ST402, the alert message is provided to the radiologist. For example, a message saying “there is a possibility that known inspection data are automatically mixed” is generated in the message generation section 11 and is then displayed by the display section 5. Displaying such a message alerts the radiologist so as to motivate him or her.

In step ST403, the interpretation data generation section 3 performs image selection to determine whether to display the uninterpreted inspection data or known abnormal data. The known abnormal data are selected in a random order depending on the mixing ratio acquired from the mixing ratio setting section 4 and are then inserted in a random position of a sequence of the uninterpreted inspection data.

In step ST404, the selected image data is displayed on the monitor 6 connected to the display section 5. As illustrated in FIG. 5, a display window 51 includes an area 52 for displaying the interpretation data and a “disease” button 53A and a “non-disease” button 53B which are used for inputting an interpretation judgment.

In step ST405, the radiologist interprets the interpretation data displayed on the display window 51. The interpretation judgment is input by pressing the disease button 53A or non-disease button 53B using a mouse or a keyboard connected to the operation section 7. The button press information (interpretation judgment) is sent to the true/false determination section 8, where the true/false of interpretation judgment is determined based on the press information of the disease button 53A or non-disease button 53B if the displayed interpretation data is the known abnormal data (step ST406).

As illustrated in FIG. 6, the totalizing section 10 has received a notification of whether each interpretation data to be displayed is the uninterpreted inspection data or known abnormal data from the interpretation data generation section 3 and manages the information and corresponding button press information. For example, in the second interpretation, the known abnormal data has been judged to be a disease image, that is, a correct judgment has been made. In this case, the interpretation data is the known abnormal data, so that it is not necessary to create the interpretation report. Thus, the message generation section 11 displays a message saying, e.g., “this image is known inspection data and it is not necessary to create interpretation report” on the monitor 6 connected to the display section 5.

In the third and fourth interpretation, the uninterpreted inspection data have each been judged to be a non-disease image, so that the interpretation report for the non-disease image is created. In the fifth interpretation, the uninterpreted inspection data has been judged to be a disease image, so that the interpretation report for the disease image is created. The radiologist can create the interpretation report according to an interpretation report creation menu displayed on the monitor 6.

In the seventh interpretation, the known abnormal data has been judged to be a non-disease image. In such a case, the message generation section 11 displays a message saying, e.g., “interpretation is incorrect” on the monitor 6 connected to the display section 5 to alert the radiologist. However, merely providing such messages for each mistake in the interpretation results in that the radiologist may take care only when the message is displayed, and correct interpretation cannot be achieved.

Thus, not only the alert message is provided to the radiologist, but also the mixing ratio of the known abnormal data set in the mixing ratio setting section 4 is changed in consideration of the true/false ratio, interpretation time, and the number of interpretations totalized by the totalizing section 10. Here, this operation is defined as an alert action.

In step ST407, it is determined whether a condition for the alert action is met. When the alert action condition is met (Yes in step ST407), the alert action is performed (step ST408). On the other hand, when the alert action condition is not met, a next interpretation data is displayed.

There are various ways to practice the alert action in step ST408.

(1) The true/false ratio is successively calculated in real time. For example, it is assumed that ten known abnormal data items are included in 1,000 interpretation data items. When erroneous determination has been made for two out of the ten known abnormal data items, the true/false ratio is 80%. If erroneous determination has been made for the first known abnormal data in the interpretation, the true/false ratio is 0%. Credibility of the interpretation result is doubted when the true/false ratio falls below the true/false ratio threshold, so that an alert message saying, e.g., “there are many interpretation mistakes; perform interpretation from the start” is provided to prompt the radiologist to perform the interpretation from the start.

(2) The mixing ratio of the known abnormal data is increased when the real-time true/false ratio falls below the true/false ratio threshold. For example, in a case where the true/false ratio threshold is 50%, the mixing ratio is increased by 10% if the true/false ratio is lowered below the threshold.

(3) An interpretation time consumed for one interpretation data is counted in the elapsed time counting section 31, and the mixing ratio of the known abnormal data is changed in accordance with the counted interpretation time. For example, in a case where the interpretation time is less than a standard interpretation time, the mixing ratio of the known abnormal data is increased. The standard interpretation time is set as the time threshold. The interpretation time consumed for one interpretation data may be calculated for each data, or an average interpretation time wherein the interpretation time of data predetermined number of data before given interpretation data is taken into consideration. Specifically, when the interpretation time is reduced to half the interpretation time at the start time of the interpretation, the mixing ratio of the known abnormal data is doubled.

(4) A time elapsed from the start of the interpretation is counted in the elapsed time counting section 31, and the mixing ratio of the known abnormal data is changed in accordance with the counted elapsed time. For example, the mixing ratio is increased by 5⁹⁶ with every 10 minutes from the start of the interpretation.

(5) The number of interpretations performed from the start of the interpretation is counted in the interpretation number counting section 32, and the mixing ratio of the known abnormal data in accordance with the counted number of the interpretations. For example, the mixing ratio of the known abnormal data is doubled upon completion of interpretation for 800 interpretation data items out of 1,000 interpretation data items.

The alert action is practiced in the manner as described above. Note that it is further effective to change the mixing ratio of the known abnormal data of a difficulty level that the radiologist is not good at.

In step ST409, it is determined whether the interpretation of all interpretation data has completed. When it is determined that the interpretation of all interpretation data has completed (Yes in ST409), the flow proceeds to step ST410 (display of interpretation result). When it is determined that the interpretation of all interpretation data has not yet completed (No in ST409), the flow returns to step ST403 and the interpretation is continued.

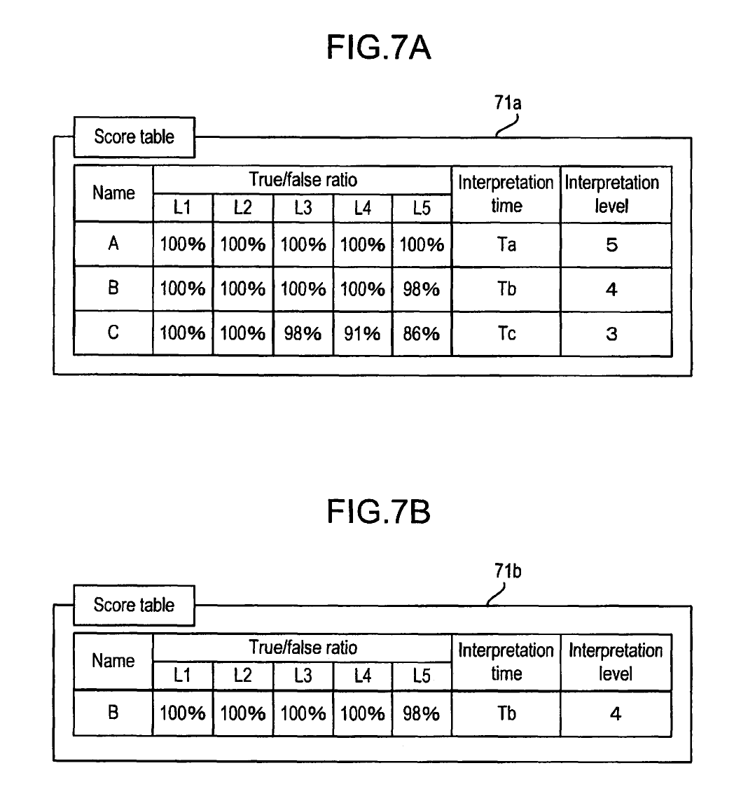

In step ST410, an interpretation result is displayed. FIGS. 7A and 7B are views each illustrating an example of display of the interpretation result. FIG. 7A illustrates a score table of all the radiologists, and FIG. 7B illustrates a score table of a given radiologist.

As illustrated in FIG. 7A, a score table 71a displays names of the radiologists, the true/false ratio obtained in accordance with the difficulty level of the known abnormal data, interpretation time, an interpretation level, and the like. A radiologist A has made a correct judgment for the known abnormal data of all the difficulty levels, and the interpretation level of the radiologist A is displayed as “5” A radiologist B has made mistakes in judgment for the known abnormal data of level L5, and the interpretation level of the radiologist B is displayed as “4”. A radiologist C has made mistakes in judgment for the known abnormal data of levels L3 to L5, and the interpretation level of the radiologist C is displayed as “3”.

Further, as a score table 71b of FIG. 7B, the score table may be configured to be accessible only by an identical radiologist (in this case, radiologist B).

Displaying the interpretation level in accordance with the interpretation result in this manner allows the radiologist to grasp an objective assessment with respect to his interpretation. The alert message is provided to a radiologist whose interpretation level has been determined to be low.

The interpretation level may be determined with the interpretation time taken into consideration. Further, in a case where the interpretation level is extremely low, the interpretation may be rejected and a message saying, e.g., “interpretation needs to be performed by another radiologist” may be provided.

In step ST411, a first round of the interpretation is completed.

The following describes the double interpretation. In a case where the score of the radiologist is low in the first round of the interpretation, an alert message saying, e.g., “true/false ratio of first radiologist is low” is displayed at the start time of a second round of the interpretation performed by a second radiologist. Such an alert message is not displayed in a case where the interpretation level of the first radiologist has reached a predetermined interpretation level.

Further, in the second round of the interpretation, a display order of the uninterpreted inspection data and an insertion order/insertion position of the known abnormal data are preferably made different from those of the first round of the interpretation.

Although the known abnormal data are inserted into a sequence of the uninterpreted inspection data in the present embodiment, the mixing ratio of the known abnormal data may be set to 0%. This may be more effective in some cases. Thus, although the alert message saying, e.g., “there is a possibility that known inspection data are automatically mixed” is provided in step ST402, there may be a case where no known abnormal data has been mixed.

Thus, according to the first embodiment, the interpretation data includes, at a predetermined mixing ratio, the uninterpreted inspection data and the known abnormal data in each of which a disease has been diagnosed. The radiologist has been previously notified that the known abnormal data are mixed in the interpretation data, so that he or she takes care not to make an erroneous determination.

Further, the radiologist himself or herself can confirm his or her true/false ratio with respect to the known abnormal data after the interpretation to thereby grasp an objective assessment/determination with respect to his or her interpretation.

Further, the inserted known abnormal data are divided into some levels in terms of ease of interpretation, so that totalizing the true/false ratio at each level allows a hospital side to grasp the interpretation level of each radiologist.

### Second Embodiment

A difference in image quality between the uninterpreted inspection data and known abnormal data, if exists, inconveniently allows the radiologist to distinguish the known abnormal data from the uninterpreted inspection data. Alternatively, a difference in magnification of a target site caused due to a difference in a photographing device or a difference in an imaging position of a target site caused due to uniqueness of a photographer inconveniently allows the radiologist to distinguish the known abnormal data from the uninterpreted inspection data. Thus, there may be a case where a sufficient number of the disease images (known abnormal data) with the same quality as that of the uninterpreted inspection data cannot be prepared.

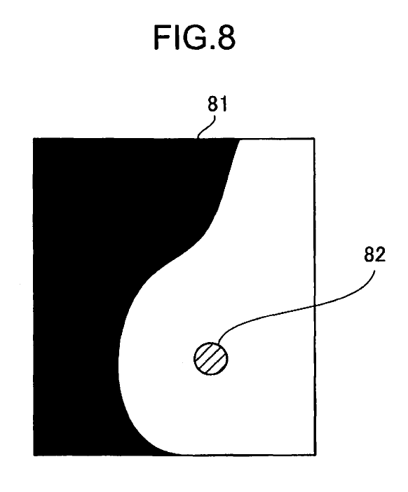

In the present embodiment, a method of artificially creating the known abnormal image data will be described as a method that solves the above problem. FIG. 8 is a view for explaining abnormal image generation processing to be performed by the abnormal image generation section 12. First, a normal image 81 is acquired from the known normal data storage section 13 of FIG. 1. The normal image 81 of FIG. 8 is a schematic view of an inspection image photographed by a mammography. Some pixels of the normal image 81 are replaced by those of an abnormal image 82 to add an abnormal site to a predetermined location, thereby obtaining the known abnormal data. The known abnormal data thus artificially generated by the abnormal image generation section 12 is stored in the known abnormal data storage section 2.

As described above, according to the second embodiment, the abnormal image is added to a part of many known normal data to create the known abnormal data, thereby solving the problem in which a sufficient number of the known abnormal data cannot be prepared. Further, changing images of lesion to be added allows the known abnormal data to be created in accordance with the interpretation level.

Further, the use of data photographed under the same condition as for the uninterpreted inspection data as the known normal data can equalize the image quality between the uninterpreted inspection data and known abnormal data, thereby reducing a possibility that the radiologist distinguishes the uninterpreted inspection data and known abnormal data.

According to the present embodiment, the known abnormal data are mixed in the interpretation data to thereby maintain the motivation of the radiologist during his or her interpretation. In addition, the alert message can be provided when the true/false ratio with respect to the known abnormal data has become low. Thus, there can be provided a medical image diagnosis system which is capable of reducing the erroneous determination in the interpretation and which is excellent in interpretation efficiency.

Although a case where the known abnormal data are inserted has been described in the present embodiment, the known normal data may additionally be inserted. This forces the radiologist to judge normal/abnormal of the interpretation data even if he or she can distinguish the known data (including normal and abnormal data) based on the image quality of the medical image as described in the second embodiment.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image interpretation system comprising:
uninterpreted inspection data;
known abnormal data in each of which a disease has been diagnosed;
an interpretation data generation section that mixes, at a predetermined mixing ratio, the known abnormal data with the uninterpreted inspection data to create interpretation data in which the known abnormal data are inserted in a random position of the uninterpreted inspection data;
a true/false determination section that determines true/false of interpretation judgment made for the known abnormal data included in the interpretation data;
a totalizing section that totalizes results of interpretation with respect to the known abnormal data; and a message generation section that generates, in accordance with the interpretation result, an alert message to a radiologist.

2. The medical image interpretation system according to claim 1, further comprising a mixing ratio setting section that resets the mixing ratio in accordance with the interpretation result.

3. The medical image interpretation system according to claim 2, wherein the mixing ratio of the known abnormal data relative to the uninterpreted inspection data includes 0%.

4. The medical image interpretation system according to claim 3, wherein
the known abnormal data are divided into some levels in terms of ease of finding an abnormal image, and
the interpretation data generation section mixes the known abnormal data of different levels in the interpretation data.

5. The medical image interpretation system according to claim 4, wherein
the message generation section generates, at the start of the interpretation, an alert message notifying the radiologist that the known abnormal data are included in the interpretation data.

6. The medical image interpretation system according to claim 5, further comprising an abnormal image data generation section that creates pseudo abnormal data by adding an abnormal image to a part of a normal medical image, wherein
the created abnormal image data is used as the known abnormal data.

7. The medical image interpretation system according to claim 6, wherein
after completion of the interpretation, the totalizing section totalizes a true/false ratio with respect to the known abnormal data for display thereof.

8. The medical image interpretation system according to claim 7, wherein
the totalizing section calculates in real time the true/false ratio with respect to the known abnormal data during the interpretation, and
when the calculated true/false ratio is equal to or less than a predetermined threshold, the message generation section generates an alert message notifying the radiologist of a decrease in the true/false ratio.

9. The medical image interpretation system according to claim 8, wherein
the mixing ratio of the known abnormal data is increased during the interpretation when the calculated true/false ratio has decreased.

10. The medical image interpretation system according to claim 9, wherein
an elapsed time counting section is provided in the totalizing section, and
the mixing ratio of the known abnormal data is increased during the interpretation when an interpretation time consumed for one interpretation data item exceeds a predetermined threshold.

11. The medical image interpretation system according to claim 10, wherein
the elapsed time counting section is provided in the totalizing section, and
the mixing ratio setting section changes the mixing ratio of the known abnormal data during the interpretation in accordance with a time elapsed from the start of the interpretation.

12. The medical image interpretation system according to claim 11, wherein
an interpretation number counting section is provided in the totalizing section, and
the mixing ratio setting section changes the mixing ratio of the known abnormal data during the interpretation in accordance with the number of images that have been interpreted from the start of the interpretation.

13. The medical image interpretation system according to claim 4, wherein
in a case where double interpretation is performed for the interpretation data, the interpretation data generation section changes an output order of the known abnormal data.

14. The medical image interpretation system according to claim 13, wherein
in the case where double interpretation is performed for the interpretation data, when the true/false ratio in a first round of the interpretation is equal to or less than a predetermined threshold, an alert message notifying the radiologist that the true/false ratio in the first round of the interpretation is low is generated at the start time of a second round.
